(19) United States
(12) Patent Application Publication
(10) Pub. No.: US 2024/0378392 A1
(43) Pub. Date: Nov. 14, 2024

(54) SYSTEMS AND METHODS FOR COMPUTING INTENT HEALTH FOR ENHANCING CONVERSATIONAL BOTS

(71) Applicant: GENESYS CLOUD SERVICES, INC., MENLO PARK, CA (US)

(72) Inventors: BASIL GEORGE, HYDERABAD (IN); RAMASUBRAMANIAN SUNDARAM, HYDERABAD (IN); SARNENDU RAHA, HYDERABAD (IN); SUDHANSHU SHEKHAR, HYDERABAD (IN); SANKET SINGH, HYDERABAD (IN)

(73) Assignee: GENESYS CLOUD SERVICES, INC., MENLO PARK, CA (US)

(21) Appl. No.: 18/661,235

(22) Filed: May 10, 2024

Related U.S. Application Data
(60) Provisional application No. 63/466,071, filed on May 12, 2023.

(51) Int. Cl. G06F 40/35; G06F 3/0484; G06N 3/006; G06Q 30/015; H04L 51/02

(52) U.S. Cl. CPC G06F 40/35; G06N 3/006; G06Q 30/015; H04L 51/02; G06F 3/0484

(57) ABSTRACT

A method for enhancing intent health of a conversational bot. The conversational bot include a machine learning model trained for natural language understanding (NLU) within a NLU domain that is defined by a collection of intents and sets of associated utterances. The method includes: retrieving the collection of intents and associated utterances; generating an utterance embedding for each of the retrieved utterances; calculating scores for utterance-level health indicators for each intent of the collection of intents; and calculating an overall intent health score for each intent of the collection of intents. The overall intent health score may be based on a weighted combination of the calculated scores for the utterance-level health indicators. The utterance-level health indicators may include an utterance in conflict indicator based on a computed semantic similarity and an utterance outlier indicator based on local density.

### CROSS REFERENCE TO RELATED APPLICATION

This application claims the benefit of U.S. Provisional Patent Application No. 63/466,071, titled “SYSTEMS AND METHODS FOR COMPUTING INTENT HEALTH FOR ENHANCING CONVERSATIONAL BOTS”, filed in the U.S. Patent and Trademark Office on May 12, 2023, the contents of which are incorporated herein.

### BACKGROUND

The present invention generally relates to telecommunications systems in the field of customer relations management including customer assistance via internet-based service options. More particularly, but not by way of limitation, the present invention pertains to systems and methods for computing intent health to enhance performance of conversational bots.

### BRIEF DESCRIPTION OF THE INVENTION

The present invention describes a method for evaluating an intent health related to a conversational bot for enhancing intent recognition. The conversational bot may include a machine learning model trained for natural language understanding (NLU) within a NLU domain that is defined by a collection of intents and sets of associated utterances. The conversational bot may be configured to select responses to provide to a customer during a conversation based on identifying a correct intent from among the collection of intents given an utterance made by the customer. Each intent may represent a different intention of the customer and is defined by the set of utterances associated therewith. The method may include the steps of: retrieving, for the conversational bot, the collection of intents and associated utterances; generating an utterance embedding for each of the retrieved utterances; calculating scores for utterance-level health indicators for each intent of the collection of intents; and calculating an overall intent health score for each intent of the collection of intents, wherein the overall intent health score is based on a weighted combination of the calculated scores for the utterance-level health indicators for the intent. When described in relation to a first intent of the collection of intents, the utterance-level health indicators may include: an utterance in conflict indicator that calculates a score based on a percentage of the utterances associated with the first intent having an utterance embedding that is computed to have a computed semantic similarity with the utterance embeddings of the utterances associated with the other intents that exceeds a first predetermined similarity threshold; and an utterance outlier indicator that calculates a score based on a percentage of the utterances associated with the first intent having an utterance embedding that is computed to have a local density that is less than local densities computed for neighboring utterance embeddings beyond an acceptable threshold level of deviation.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 depicts a schematic block diagram of an exemplary intent health computation system in accordance with an embodiment of the present invention; and

FIG. 4 depicts a method for computing intent health in accordance with an exemplary embodiment of the present invention.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily referring to the same embodiment or example. Further, particular features, structures or characteristics may be combined in any suitable combinations and/or sub-combinations in one or more embodiments or examples.

Those skilled in the art will recognize from the present disclosure that the various embodiments may be computer implemented using many different types of data processing equipment, with embodiments being implemented as an apparatus, method, or computer program product. Example embodiments, thus, may take the form of an entirely hardware embodiment, an entirely software embodiment, or an embodiment combining software and hardware aspects. Example embodiments further may take the form of a computer program product embodied by computer-usable program code in any tangible medium of expression. In each case, the example embodiment may be generally referred to as a “module”, “system”, or “method”.

### Computing Device

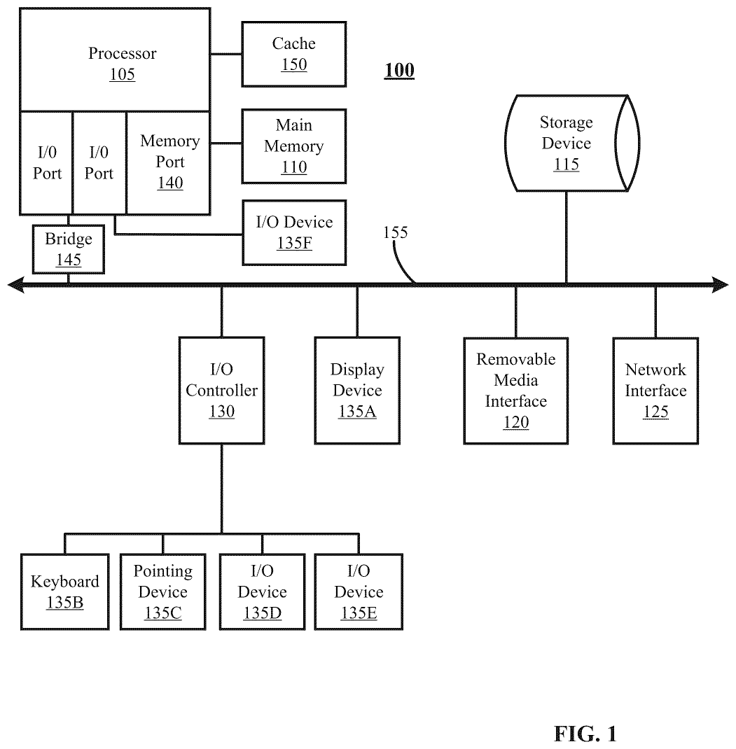

It will be appreciated that the systems and methods of the present invention may be computer implemented using many different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

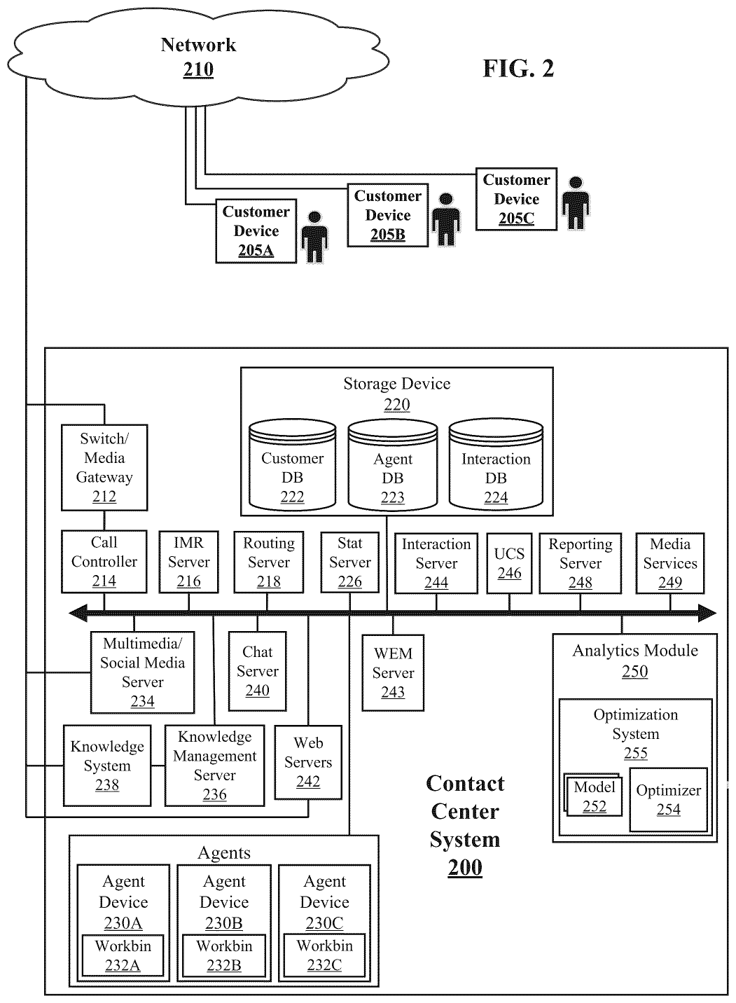

The computing device 100, for example, may be implemented via firmware (e.g., an application-specific integrated circuit), hardware, or a combination of software, firmware, and hardware. It will be appreciated that each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center system 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. The computing device 100 include a plurality of devices connected by a network or connected to other systems and resources via a network. As used herein, a network includes one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. It should be understood that, unless otherwise limited, the computing device 100 may communicate with other computing devices 100 via any type of network using any conventional communication protocol. Further, the network may be a virtual network environment where various network components are virtualized.

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and the like.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; and analytics module 250. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C-it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VOIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource.

In regard to the routing server 218, it may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices-represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VOIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C-it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems and methods for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VOIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Intent Health and Conversational Bots

Modern contact centers regularly employ conversational bots. A conversational bot is typically trained by first defining intents and utterances by a bot author. Broadly, intents refer to customer goals or intentions that the bot need to fulfil or respond to. Utterances denote the various ways in which a customer can describe these goals or intentions. Together, they form an NLU domain. In order to train good machine learning models for natural language understanding (NLU), defining the right set of intents and utterances is of great importance. Bad NLU models result in bots with poor accuracy leading to customer frustration.

Generally, NLU models report a variety of metrics to denote their performance like precision, recall, accuracy, etc. This is usually reported on a test data set containing intents and utterances, which is different from the data set used for training. While such metrics help understand and compare the overall performance of different models, they do not provide more granular information regarding the specific intents and/or utterances in an NLU domain that contribute to performance degradation. While confusion matrices on test data may help give some indication as to problematic intents, they do not prescribe any specific action on any utterance present in the NLU domain. The problem gets more severe when the number of intents and utterances present increases. Providing an overall number to indicate model performance may not be very useful for bot authors unless problematic entries in an NLU domain are identified. In this way, corrective actions are enabled that improve functionality.

In this disclosure, a method of computing what will be referred to herein as “intent health” of an NLU domain is proposed. As will be seen, this method allows users to quickly identify and highlight potential issues that might cause performance degradation of an NLU model. Intent health may be described in terms of a set of metrics, warnings or suggestions related to issues with an NLU domain. While the method described here is not tailored to any specific machine learning model that can be used for the purposes of natural language understanding, it may work best with those that use word embeddings or its variations as features.

The idea of intent health can be expanded to cover “bot health” too. A conversational bot can be envisaged as consisting of a dialogue flow definition, an NLU domain, and a knowledge base, among other components. The dialogue flow definition helps orchestrate the dialogue between the bot and a customer. It may define the hierarchy or set of intents that need to be considered for detection at different turns of the conversation, as well as any the follow up questions that need to be asked to the customer to perform any data actions that are required for intent fulfilment.

Bots may be designed to contain an associated knowledge base in addition to or in place of an NLU domain. The knowledge base defines a set of questions with associated answers, like an FAQ collection. If the bot needs to only detect such questions and provide static answers present in the knowledge base, then only a knowledge base needs to be present and not an NLU domain. Such a bot may be called a “knowledge bot”. In other cases, both transactional and informational queries need to be answered by a bot. This will require both an NLU domain and a knowledge base to be associated with a bot. Such bots are often referred to as “hybrid bots”.

In all these scenarios, it is important to understand the overall quality of the bot or bot health. As used herein, “bot health” may be considered in terms of complexity or confusability of dialogue flow definition, quality of knowledge articles being created, and health of intents while seen in conjunction with knowledge articles. As an example of the latter, consider a case where an intent utterance is duplicated as a knowledge article title. If a customer asks the same or a similar utterance as query, then the system may get confused as to whether to fulfil data actions related to the intent or surface the answer related to knowledge as both the intent gets detected and the knowledge article title gets matched. Thus, bot health needs to consider these different scenarios related to different types of bots. The current disclosure is particularly related to the case of NLU domain, and not knowledge base, as associated with a bot. Hence, bot health, as used herein, may be considered largely in terms of intent health.

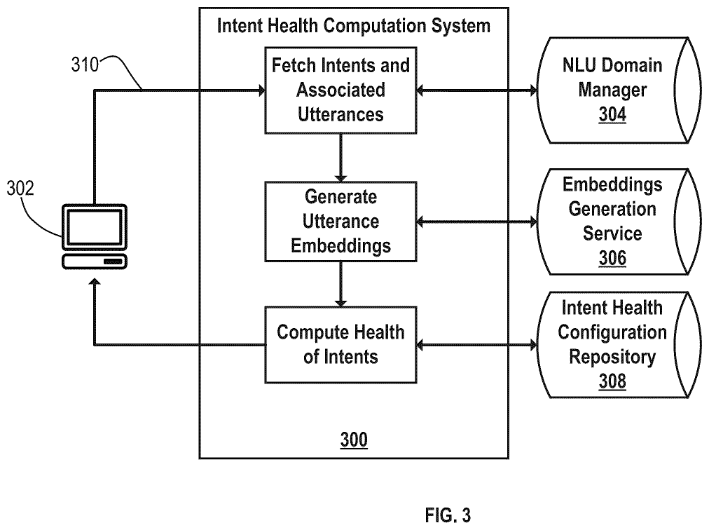

With reference now to FIG. 3, an intent health computation system 300 is shown in accordance with exemplary embodiments of the present invention. Once a bot author creates a bot via a collection of intents and associated utterances and saves the NLU domain, a request may be sent from a client 302 to the intent health computation system 300 to compute the health metrics for that domain. As shown, the intent health computation system 300 may operate in conjunction with a NLU domain manager 304, an embeddings generation service 306, and an intent health configuration repository 308. For simplicity, it may be assumed that the NLU domain is mono-lingual. In the case of multi-lingual NLU domains where intents and utterances belonging to multiple languages are separately defined, intent health may be computed for each language independently and parallelly without any major change in the system described.

A request 310 may be sent from the client to the intent health computation system 300 in relation to the intents of a particular computational bot. Once the request is received, the intent health computation system 300 may fetch the collection of intents and associated utterances belonging to the NLU domain of the bot from an NLU Domain Manager 304. The NLU Domain Manager 304 is responsible for maintaining and updating the NLU domain information according to the changes made by the bot author.

The intent health computation system 300 then generates utterance embeddings for the each of the retrieved utterances, for example, via the embeddings generation service 306. For computation of intent health, it is important to have high quality vector-based representation of utterances, also called utterance embeddings, which accurately captures the semantic information present in the utterances. For example, the embeddings generation service 306 may use Transformer-based Deep Learning techniques to generate high quality embeddings. Such Transformer-based models may be used to train Large Language Models (LLMs) with proven accuracy. Using off-the-shelf Transformer models from the public domain may not be feasible due to large memory requirements and high latency involved. Intent Health metrics should be computed and presented to the user within seconds of the bot author making any change in the NLU domain for a good user experience. Hence, teacher-student model distillation techniques may also be employed to reduce the size and latency of such Transformer models. Such distilled models may be hosted and made available as a separate service so that sufficient abstraction is achieved between the intent health computation process and the embedding generation process.

As shown, once the utterance embeddings are generated, intent health computation system 300 may calculate intent health. The calculated health metrics may be stored in a data base, for example, the intent health configuration repository 308, for future retrieval. The calculated intent health metrics are also provided to the client 302 for presenting to the bot author. As described below, the bot author may make further changes based on the results for improving the intent health of the bot and, thereby, conversational performance. The user interface provided to the bot author may dynamically update health results per changes made by the user to the collection of intents and associated utterances. For example, the bot author, after reviewing the health indicators, may make further modifications to the NLU domain (i.e., the collection of intents and associated utterances) which then gets captured and triggers a recomputing of the intent health metrics. This may be an iterative process until the bot author deems that the NLU domain is in good health. Then the bot can be trained and deployed to serve customer requests.

Various embodiments for computing intent health will now be discussed. Intent Health may be regarded as an indicator of the overall health of an intent. Different labels may be used to describe the health of an intent, such as, “Good” or “Ok”, or “Poor”. These labels may be derived by mapping intent health scores (e.g., out of 100) to specific thresholds. For example, an intent health score greater than 90 may be labeled as “Good”, a health score between 70 and 90 may be labeled as “Ok”, and a score less than 70 may be labeled as “Poor”.

In accordance with exemplary embodiments, since intents are constituted by utterances, it is possible to talk about intent health in terms of the health of its constituent utterances. The following discussion describes several exemplary utterance-level health indicators in accordance with the present invention.

A first utterance-level health indicator may be referred to as an utterance in conflict indicator. This health indicator indicates that an utterance in a first intent is semantically very similar to an utterance in another intent. Since utterances belonging to two different intents are very similar to each other, there is a chance that the NLU models may find the intents confusing, leading to poor model performance. For good NLU models, it is recommended that no utterances be in conflict, or substantially similar, across any pair of intents.

In accordance with exemplary embodiments, the calculated utterance embeddings can be used to compute similarity between a pair of utterances. For example, a cosine similarity score ranging between 0 and 1 gives a good indication of similarity between two utterances. The higher the score, the higher the similarity. An appropriate threshold may be chosen so that pairs of utterances across different intents whose similarity scores are above this threshold would be deemed as being in conflict, i.e., as utterances in conflict. This threshold may be language dependent as sentence embeddings of a sentence expressed in different languages may differ from each other. This threshold for each language may be obtained after extensive evaluation of similarity scores using large utterance datasets.

A second utterance-level health indicator may be referred to as a similar utterance indicator. This health indicator indicates that an utterance is very similar to another utterance within the same intent. While the severity of this health indicator may not as high as the utterance in conflict indicator, it is nonetheless significant to avoid utterances that are very similar to each other in the same intent, for example, differing only in punctuations, auxiliary verbs, prepositions, etc., as these add no value while consuming additional memory. In accordance with exemplary embodiments, two utterances within the same intent may be flagged as being too similar if their similarity score is above a threshold. The threshold in this case may need to be higher than the threshold set for the utterance in conflict threshold as more similar utterances within the same intent are allowed than across different intents. For example, in the case of the English language, 0.75 may be set as threshold of the utterance in conflict threshold while the threshold for the similar utterance indicator may be set as 0.95.

A third utterance-level health indicator may be referred to as an outlier utterance indicator. This health indicator indicates that an utterance is an outlier within a given intent. That is, the utterance is flagged as being an anomaly in relation to the other set of utterances present in a given intent. Such an utterance may have been added due to error and should be removed, otherwise more variations of such the utterance may be added in the intent so that NLU model learns the pattern sufficiently. In accordance with an exemplary embodiment, outlier detection may be performed using an approach called Local Outlier Factor (LOF), which is an unsupervised anomaly detection algorithm that computes the local density deviation of a given utterance embedding with respect to its neighbors in the N-dimensional space, with N being the dimension of the embedding vector. The samples that have significantly lower density than its neighbors are considered outliers among the given set of utterances within an intent. Thus, the utterance outlier indicator may calculate a percentage of the utterances associated with a given intent having an utterance embedding that has a local density that is less than the local densities of neighboring utterance embeddings beyond an acceptable threshold level of deviation. A locality or neighborhood is given by k-nearest neighbors of a data point whose distance is used to calculate the local density. In an exemplary embodiment, the value of k is set at one-third of the number of utterances present in an intent (rounded to the nearest integer), with the lower and upper bounds set at 5 and 20. In some embodiments, the outlier utterance indicator is not computed for intents with less than 5 utterances. A distance metric of cosine similarity may be used to compute local densities. Nearest neighbors search may be done by either KDTree or BallTree algorithm, with the particular choice being made based on the incoming data. LOF scores may then be used to bare used to determine whether an utterance is an outlier or not. These scores start at 0, with any LOF score greater than 2 being considered an outlier.

A fourth utterance-level health indicator may be referred to as an utterance-level static validation indicator. In accordance with exemplary embodiments, this health indicator may include flagging utterances associated with a given intent that are too short and/or too long. For example, an utterance too short indicator is a type of utterance-level static validation that indicates that an utterance is too short. As an example, single word utterances may be avoided as intents are more fully expressed in terms of action-object pairs. Once flagged as being too short, bot authors are encouraged to make utterances longer and more descriptive. This indicator can be assigned by counting the number of tokens or words present or counting the number of characters present in an utterance. For example, in the case of the English language, this indicator may be provided if the number of words is less than 2 or the number of characters present is less than 2.

On the other side, the utterance-level static validation indicator may include an utterance too long indicator that indicates that an utterance is too long. Most NLU models have a maximum length limit as to the number of words or tokens that can be efficiently consumed in relation to an utterance. Further, an exceedingly long utterance might bring in diverse intents that make model convergence difficult or erroneous. An indicator that an utterance is too long can assist bot authors by prodding them to revisit long utterances and make them more concise. This indicator too can be assigned by counting the number of tokens or words present or counting the number of characters present in an utterance. For example, if the number of words present is greater than 50 or 100 or the number of characters present is greater than 250 or 500, an utterance too long indication may be provided to the user.

In regard to intent-level health indicators, the present disclosure proposes health indicators that flag occasions when there are too many and/or too few utterances associated with a given intent. Such health indicators may be referred to generally as an intent-level static validation indicator, which may include both a too many utterances indicator and a too few utterances indicator.

The too many utterances indicator functions by flagging instances in which there are too many utterances associated with an given intent. It is observed that thousands of utterances are not required to capture the diverse ways in which an intent may be expressed by customers. If they are indeed required, then it generally is advisable to split the intent into multiple intents. Otherwise, it might lead to a high false positive rate for the intent in the model. The maximum number of utterances allowed per intent may be set sufficiently high, such as 500 or 1000, and an indication of too many utterances can be provided to a user if this limit is exceeded.

The too few utterances indicator functions by flagging instances in which there are too few utterances associated with an given intent. As will be appreciated, having too few utterances can negatively impact performance, for example, if there are very few utterances, the model parameters may not be sufficiently trained to capture enough variations of the intent. This might result in low precision for the intent in the model. The minimum number of utterances per intent may be set sufficiently low, such as 5 or 10. The too few utterances indicator then function to flag instances when an intent does not meet this minimum limit.

The thresholds described above related to the several metrics or health indictors can be made configurable by the bot author. This process may be enabled via sliding scales or other input mechanism that is generated via user display for receiving input from a user. For example, in exemplary embodiments, bot authors can adjust each of the metric thresholds so that health indicators are suitably configured. Some health indicators may be disabled as well through this process. For example, if the threshold of the utterance too short indicator is reduced to 0 tokens or 0 characters, then no utterance will be marked with that health indicator. Such intent health configurations specific to each customer organization are stored in intent health configuration repository 308, which may be retrieved during the health computation process.

In accordance with exemplary embodiments, overall health of an intent can be computed using its constituent utterance-level health indicators and intent-level health indicators. To do this, for each utterance-level health indicator such as Utterance in Conflict or Outlier Utterance, the percentage of utterances within an intent having this indicator assigned is computed. Overall “unhealthiness” of an intent is then computed by taking weighted average of these percentages with weights denoting a relative importance of each of the indicators. In accordance with a preferred embodiment, based on certain experiments and feedback from users, the following percentage weights are used:
Utterance in Conflict: 60%
Similar Utterance: 5%
Outlier Utterance: 15%
Utterance-level Static Validation: 20%

This denotes that the health indicators in the descending order of severity are the utterance in conflict indicator, utterance-level static validation indicator, outlier utterance indicator, and similar utterance indicator. Thus, the utterance in conflict indicator is the most important health indicator and should be addressed as a priority by the bot author in order to improve the NLU model performance in the most impactful manner. From the calculate “unhealthiness” score, a health score for each intent is obtained by subtracting this from 100.

If the intent is further found to violate an intent-level static validation indicator, then the health score is further negatively impacted to reflect a final health score. In this case, a constant α may be subtracted from the previously calculated score. In an exemplary embodiment, the constant α may be set at a value of 10.

Given this configuration, the lower bound of the health score becomes 0 and the upper bound becomes 100. Further, intent health score computation can be generalized as:

$$Intent Health Score = max ( 0 , 100 - ( {\sum }_{i} {w}_{i} * {p}_{i} / {\sum }_{i} {w}_{i} ) - α ) ,$$

where wᵢ is the weight of ith health indicator and pᵢ is the percentage of utterances within the intent having that indicator assigned. And α is the value of the constant by which the score is further reduced in case an intent-level health indicator is assigned to that intent.

Consider the following intent health computation example. In this example, an intent has 50 associated utterances, out of which:
15 (30%) of the 50 utterances are flagged as being Utterance in Conflict
5 (10%) of the 50 utterances are flagged as being Similar Utterance
5 (10%) of the 50 utterances are flagged as being Outlier Utterance
10 (20%) of the 50 utterances are flagged as being Utterance too Short
10 (20%) of the 50 utterances are flagged as being Utterance too Long
0 flags related to the Intent-level Static Validation Indicator
   The health can be computed as:

$$\begin{matrix}intent health score = 100 - ( 60 \times 30 + 5 \times 10 + 15 \times 10 + 20 \times 40 ) / \\ ( 60 + 5 + 15 + 20 ) - 0 \\ = 100 - 28 - 0 = 72\end{matrix}$$

By the scale introduced above, this may be labeled as “Ok” intent health since the health score is between 70 and 90. If after presenting this health report, the user modifies the intent so that, now, out of the 50 utterances:
5 (10%) of the 50 utterances are flagged as being Utterance in Conflict
0 (0%) of the 50 utterances are flagged as being Similar Utterance
5 (10%) of the 50 utterances are flagged as being Outlier Utterance
0 (0%) of the 50 utterances are flagged as being Utterance too Short
0 (0%) of the 50 utterances are flagged as being Utterance too Long
0 flags related to the Intent-level Static Validation Indicator
   The updated health of the intent becomes:

$$\begin{matrix}intent health score = 100 - ( 60 \times 10 + 5 \times 0 + 15 \times 10 + 20 \times 0 ) / \\ ( 60 + 5 + 15 + 20 ) - 0 \\ = 100 - 7.5 - 0 = 92.5\end{matrix}$$

As modified, the intent now achieves “Good” intent health as the health score is above 90. To continue the example, if an intent-level static validation indicator, like Too Many Utterances, had been flagged or assigned to this intent, then the health score would have gotten reduced by 10 and would have become 82.5, and the label of the intent would have been “Ok” intent health.

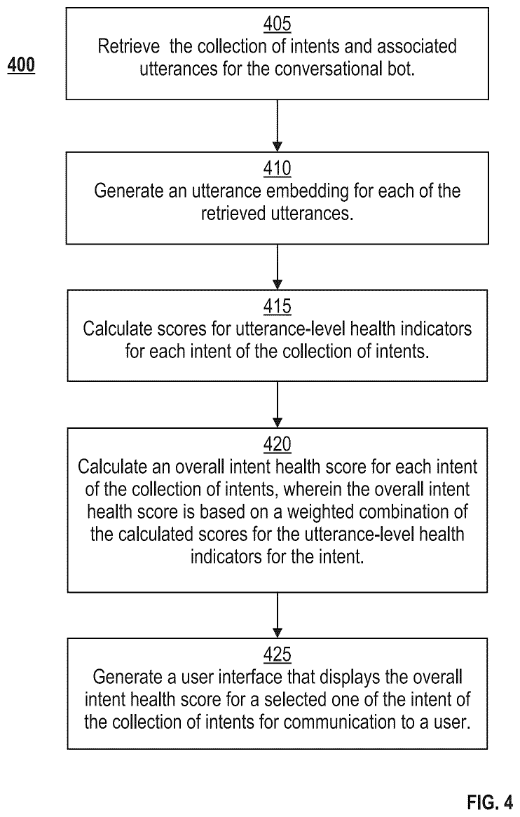

With reference to FIG. 4, a method 400 is depicted for computing intent health in accordance with an exemplary embodiment of the present invention. The method may be used to evaluate an intent health related to a conversational bot for enhancing intent recognition. In exemplary embodiments, the conversational bot may include a machine learning model trained for natural language understanding (NLU) within a NLU domain that is defined by a collection of intents and sets of associated utterances. In exemplary embodiments, the conversational bot may be configured to select responses to provide to a customer during a conversation based on identifying a correct intent from among the collection of intents given an utterance made by the customer. Each intent may represent a different intention of the customer and is defined by the set of utterances associated therewith. The method 400 begins, at step 405, by retrieving for the conversational bot the collection of intents and associated utterances. At step 410, the method 400 continues by generating an utterance embedding for each of the retrieved utterances. At step 415, the method 400 continues by calculating scores for utterance-level health indicators for each intent of the collection of intents. At step 420, the method 400 continues by calculating an overall intent health score for each intent of the collection of intents, wherein the overall intent health score is based on a weighted combination of the calculated scores for the utterance-level health indicators for the intent. At step 425, the method 400 continues by generating a user interface that displays the overall intent health score for a select one of the intents (hereinafter “selected intent”) of the collection of intents for communication to a user.

In accordance with exemplary embodiments, the utterance-level health indicators may include an utterance in conflict indicator. When described in relation to an exemplary first intent of the collection of intents, the utterance in conflict indicator calculates a score based on a percentage of the utterances associated with the first intent having an utterance embedding that is computed to have a computed semantic similarity with the utterance embeddings of the utterances associated with the other intents that exceeds a first predetermined similarity threshold.

In accordance with exemplary embodiments, the utterance-level health indicators may further include an utterance outlier indicator. When described in relation to the exemplary first intent of the collection of intents, the utterance outlier indicator calculates a score based on a percentage of the utterances associated with the first intent having an utterance embedding that is computed to have a local density that is less than local densities computed for neighboring utterance embeddings beyond an acceptable threshold level of deviation. In calculating the utterance outlier indicator, the local densities may each be calculated via an anomaly detection algorithm that computes the local density of a given utterance embedding with respect to neighboring utterance embeddings in N-dimensional space wherein N is a dimension of an embedding vector of the utterance embeddings.

In accordance with exemplary embodiments, the method may further include the step of calculating an intent level health indicator that is an intent-level static validation indicator. When described in relation to the first intent of the collection of intents, the intent-level static validation indicator may include: a too many utterances indicator that determines whether a number of utterances associated with the first intent exceeds a maximum threshold; and a too few utterances indicator that determines whether the number of utterances associated with the first intent less than a minimum threshold. In such cases, the overall intent health score may be based on a weighted combination of the calculated scores for the utterance-level health indicators and the intent-level static validation indicator. For example, when the number of utterances associated with the first intent either exceeds or is found to be less than the maximum threshold or minimum threshold, respectively, the step of calculating the overall intent health score for each intent may further include subtracting a predetermined constant from the weighted combination of the calculated scores for the utterance-level health indicators for the intent.

In accordance with exemplary embodiments, the utterance-level health indicators may further include a similar utterance indicator. When described in relation to the exemplary first intent of the collection of intents, the similar utterance indicator calculates a score based on a percentage of the utterances associated with the first intent comprising an utterance embedding that is computed to have a semantic similarity with the other utterance embeddings of the utterances associated with the first intent that exceeds a second predetermined similarity threshold. In exemplary embodiments, the first predetermined similarity threshold may be set at a level of semantic similarity that is less than the level of semantic similarity of the second predetermined similarity threshold. Semantic similarity may be calculated using cosine similarity, though other methods of calculation are also possible.

In accordance with exemplary embodiments, the utterance-level health indicators may further include an utterance-level static validation indicator. When described in relation to the exemplary first intent of the collection of intents, the utterance-level static validation indicator calculates a score based on a percentage of the utterances associated with the first intent found to have a total number of words or characters that either exceeds a maximum threshold or is less than a minimum threshold.

In accordance with exemplary embodiments, the generated user interface may further display the calculated scores for the utterance-level health indicators and the intent-level static validation indicator for the select intent that are used to calculate the overall intent health score for the select intent. In such cases, the generated user interface may further display one or more utterances found to exceed the first predetermined threshold related to the utterance in conflict indicator. The one or more utterances may be displayed in proximity to or in spaced relation to the score displayed for the utterance in conflict indicator. Similarly, the generated user interface may further display one or more utterances found to exceed the acceptable threshold level of deviation related to the utterance outlier indicator. The one or more utterances may be displayed in proximity to or in spaced relation to the score displayed for the utterance outlier indicator. Similar functionality may also be provided related to any of the other indicators. The method may further include the step of receiving input from the user modifying at least one of the one or more utterances found to exceed one of the thresholds. For example, input may be received from the user that deletes one or more utterance found to exceed the first predetermined threshold associated with the utterance in conflict indicator or deletes one or more utterances found to exceed the acceptable threshold level of deviation associated with the utterance outlier indicator. In such cases, the method may further include the steps of dynamically updating the user interface by recalculating the overall intent health score for the select intent for communication to the user and the included sub-scores related to the indicators. This type of dynamic feedback may allow a user to improve intent health in a highly efficient manner.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A method for evaluating an intent health related to a conversational bot for enhancing intent recognition, wherein the conversational bot comprises a machine learning model trained for natural language understanding (NLU) within a NLU domain that is defined by a collection of intents and sets of associated utterances, wherein the conversational bot is configured to select responses to provide to a customer during a conversation based on identifying a correct intent from among the collection of intents given an utterance made by the customer, wherein each intent comprises a different intention of the customer and is defined by the set of utterances associated therewith, the method comprising the steps of:
retrieving, for the conversational bot, the collection of intents and associated utterances;
generating an utterance embedding for each of the retrieved utterances;
calculating scores for utterance-level health indicators for each intent of the collection of intents;
calculating an overall intent health score for each intent of the collection of intents, wherein the overall intent health score is based on a weighted combination of the calculated scores for the utterance-level health indicators for the intent;
wherein, when described in relation to a first intent of the collection of intents, the utterance-level health indicators comprise:
an utterance in conflict indicator that calculates a score based on a percentage of the utterances associated with the first intent comprising an utterance embedding that is computed to have a computed semantic similarity with the utterance embeddings of the utterances associated with the other intents that exceeds a first predetermined similarity threshold; and
an utterance outlier indicator that calculates a score based on a percentage of the utterances associated with the first intent comprising an utterance embedding that is computed to have a local density that is less than local densities computed for neighboring utterance embeddings beyond an acceptable threshold level of deviation.

2. The method of claim 1, further comprising the step of:
calculating an intent level health indicator comprising an intent-level static validation indicator, wherein, when described in relation to the first intent of the collection of intents, the intent-level static validation indicator comprises:
a too many utterances indicator that determines whether a number of utterances associated with the first intent exceeds a maximum threshold; and
a too few utterances indicator that determines whether the number of utterances associated with the first intent less than a minimum threshold.

3. The method of claim 2, wherein the overall intent health score is based on a weighted combination of the calculated scores for the utterance-level health indicators and the intent-level static validation indicator.

4. The method of claim 3, wherein, in calculating the utterance outlier indicator, the local densities are each calculated via an anomaly detection algorithm that computes the local density of a given utterance embedding with respect to neighboring utterance embeddings in N-dimensional space wherein N is a dimension of an embedding vector of the utterance embeddings.

5. The method of claim 3, wherein, when the number of utterances associated with the first intent either exceeds or is found to be less than the maximum threshold or minimum threshold, respectively, the step of calculating the overall intent health score for each intent further comprises subtracting a predetermined constant from the weighted combination of the calculated scores for the utterance-level health indicators for the intent.

6. The method of claim 3, wherein, when described in relation to the first intent of the collection of intents, the utterance-level health indicators further comprise:
a similar utterance indicator that calculates a score based on a percentage of the utterances associated with the first intent comprising an utterance embedding that is computed to have a semantic similarity with the other utterance embeddings of the utterances associated with the first intent that exceeds a second predetermined similarity threshold.

7. The method of claim 6, wherein the first predetermined similarity threshold comprises a level of semantic similarity that is less than a level of semantic similarity of the second predetermined similarity threshold; and
wherein semantic similarity is calculated using cosine similarity.

8. The method of claim 6, wherein, when described in relation to the first intent of the collection of intents, the utterance-level health indicators further comprise:
an utterance-level static validation indicator that calculates a score based on a percentage of the utterances associated with the first intent found to have a total number of words or characters that either exceeds a maximum threshold or is less than a minimum threshold.

9. The method of claim 3, further comprising the step of generating a user interface that displays the overall intent health score for a select intent of the collection of intents for communication to a user.

10. The method of claim 9, wherein the generated user interface further displays the calculated scores for the utterance-level health indicators and the intent-level static validation indicator for the select intent that are used to calculate the overall intent health score for the select intent.

11. The method of claim 9, wherein:
in proximity to the score displayed for the utterance in conflict indicator, the generated user interface further displays one or more utterances found to exceed the first predetermined threshold; and
in proximity to the score displayed for the utterance outlier indicator, the generated user interface further displays one or more utterances found to exceed the acceptable threshold level of deviation.

12. The method of claim 11, further comprising the steps of:
receiving input from the user modifying at least one of the one or more utterances found to exceed the first predetermined threshold or the one or more utterances found to exceed the acceptable threshold level of deviation; and
dynamically updating the user interface by recalculating the overall intent health score for the select intent for communication to the user.

13. A system for evaluating an intent health related to a conversational bot for enhancing intent recognition, wherein the conversational bot comprises a machine learning model trained for natural language understanding (NLU) within a NLU domain that is defined by a collection of intents and sets of associated utterances, wherein the conversational bot is configured to select responses to provide to a customer during a conversation based on identifying a correct intent from among the collection of intents given an utterance made by the customer, wherein each intent comprises a different intention of the customer and is defined by the set of utterances associated therewith, the system comprising:
a processor; and
a memory storing instructions which, when executed by the processor, cause the processor to perform the steps of:
retrieving the collection of intents and associated utterances for the conversational bot;
generating an utterance embedding for each of the retrieved utterances;
calculating scores for utterance-level health indicators for each intent of the collection of intents;
calculating an overall intent health score for each intent of the collection of intents, wherein the overall intent health score is based on a weighted combination of the calculated scores for the utterance-level health indicators for the intent;
wherein, when described in relation to a first intent of the collection of intents, the utterance-level health indicators comprise:
an utterance in conflict indicator that calculates a score based on a percentage of the utterances associated with the first intent comprising an utterance embedding that is computed to have a computed semantic similarity with the utterance embeddings of the utterances associated with the other intents that exceeds a first predetermined similarity threshold; and
an utterance outlier indicator that calculates a score based on a percentage of the utterances associated with the first intent comprising an utterance embedding that is computed to have a local density that is less than local densities computed for neighboring utterance embeddings beyond an acceptable threshold level of deviation, wherein, in calculating the utterance outlier indicator, the local densities are each calculated via an anomaly detection algorithm that computes the local density of a given utterance embedding with respect to neighboring utterance embeddings in N-dimensional space wherein N is a dimension of an embedding vector of the utterance embeddings.

14. The system of claim 13, wherein the memory stores further instructions which, when executed by the processor, cause the processor to perform the steps of:
calculating an intent level health indicator comprising an intent-level static validation indicator, wherein, when described in relation to the first intent of the collection of intents, the intent-level static validation indicator comprises:
a too many utterances indicator that determines whether a number of utterances associated with the first intent exceeds a maximum threshold; and
a too few utterances indicator that determines whether the number of utterances associated with the first intent less than a minimum threshold;
wherein the overall intent health score is based on a weighted combination of the calculated scores for the utterance-level health indicators and the intent-level static validation indicator.

15. The system of claim 14, wherein, when described in relation to the first intent of the collection of intents, the utterance-level health indicators further comprise:
a similar utterance indicator that calculates a score based on a percentage of the utterances associated with the first intent comprising an utterance embedding that is computed to have a semantic similarity with the other utterance embeddings of the utterances associated with the first intent that exceeds a second predetermined similarity threshold.

16. The system of claim 15, wherein, when described in relation to the first intent of the collection of intents, the utterance-level health indicators further comprise:
an utterance-level static validation indicator that calculates a score based on a percentage of the utterances associated with the first intent found to have a total number of words or characters that either exceeds a maximum threshold or is less than a minimum threshold.

17. The system of claim 14, wherein the memory stores further instructions which, when executed by the processor, cause the processor to perform the steps of:
generating a user interface that displays the overall intent health score for a select intent of the collection of intents for communication to a user.

18. The system of claim 17, wherein the generated user interface further displays the calculated scores for the utterance-level health indicators and the intent-level static validation indicator for the select intent that are used to calculate the overall intent health score for the select intent.

19. The system of claim 18, wherein:
in proximity to the score displayed for the utterance in conflict indicator, the generated user interface further displays one or more utterances found to exceed the first predetermined threshold; and
in proximity to the score displayed for the utterance outlier indicator, the generated user interface further displays one or more utterances found to exceed the acceptable threshold level of deviation.

20. The system of claim 19, wherein the memory stores further instructions which, when executed by the processor, cause the processor to perform the steps of:
receiving input from the user modifying at least one of the one or more utterances found to exceed the first predetermined threshold or the one or more utterances found to exceed the acceptable threshold level of deviation; and
dynamically updating the user interface by recalculating the overall intent health score for the select intent for communication to the user.
